(19) United States
(12) Patent Application Publication
(10) Pub. No.: US 2010/0194548 A1
(43) Pub. Date: Aug. 5, 2010

(54) DOWNTIME MONITORING APPARATUS AND METHOD

(75) Inventors: Kent Tabor, Pewaukee, WI (US); Ryan Nowak, Pewaukee, WI (US)

Correspondence Address: REINHART BOERNER VAN DEUREN P.C., 2215 PERRYGREEN WAY, ROCKFORD, IL, 61107, US

(73) Assignee: TM INDUSTRIALS, LLC, Hartland, WI (US)

(21) Appl. No.: 12/696,113

(22) Filed: Jan. 29, 2010

Related U.S. Application Data
(60) Provisional application No. 61/148,779, filed on Jan. 30, 2009.

(51) Int. Cl. G08B 5/00; H04B 3/36

(52) U.S. Cl. 340/425.1; 340/815.4; 340/815.65

(57) ABSTRACT

An apparatus and method are provided for monitoring and facilitating a process, through the use of wirelessly-linked, portable signal units. The signal units have one or more signal lights, and can be placed adjacent to process stations. When a signal light is actuated by operator input at one or more of the process stations, the lights at all of the other process stations also are illuminated in a recognizable pattern to enhance visibility and identification at a glance as to which process station needs attention. Signal units also can function as repeaters to facilitate communication and operation. Designation of certain signal units as repeaters and optimization of communication between signal units is automatically carried out in accordance with one or more optimization approaches. In an embodiment, a time-based record of operation of the signal lights is provided for process monitoring and improvement.

### CROSS-REFERENCE TO RELATED PATENT APPLICATIONS

This patent application claims the benefit of U.S. Provisional Patent Application No. 61/148,779, filed on Jan. 30, 2009, the entire teachings and disclosure of which are incorporated herein by reference thereto.

### FIELD OF THE INVENTION

This invention relates generally to processes in manufacturing, assembly, fabrication used in commercial and industrial settings, and more particularly to a portable and adaptable system and method for use in such settings for monitoring and correcting problem conditions and for enhancing quality and productivity.

### BACKGROUND OF THE INVENTION

Since the industrial revolution, almost every aspect of the manufacturing, assembly, storage, shipping, distribution and sale of products has become increasingly automated. Many processes are carried out in an assembly-line fashion with operations being performed sequentially at a number of successively arranged stations. In other settings, a number of highly automated machines may be used for simultaneously performing a given step in a process.

To keep such highly automated systems and processes running smoothly, it is typically necessary to monitor the various process stations, in some fashion, to ensure that the process is being performed correctly at a given station and to address any problems which might occur.

Although the automation of machinery and processes has reached a level of sophistication which could not have even been dreamed of only a few years ago, most automated processes still require some degree of supervision and oversight by human operators. Even in settings where fully automated processes are possible, at least theoretically, the financial burden to put such fully automated processes in place is often prohibitive. Accordingly, there still exists a need for monitoring systems capable of operation even in highly automated settings which alert a human operator to a problem, or a need to be met by the machinery or process.

In one prior approach to providing such a system, known in the industry as an “andon” system, some form of a signaling device, which may be as simple as a rope and pulley arrangement connected to a remote switch, is utilized by an operator for illuminating a light on an enunciation panel located remotely from the station at which a process is being carried out. When a problem occurs at the process station, an operator at the station can trigger the remote enunciation light to alert repair or re-supply personnel that attention is needed at that particular station. The operator at the station can then remain at his post carrying out his assigned task on other machinery at the station, while the repair or resupply personnel deal with the problem that triggered the lighting of the enunciation signal. In this manner, a skilled operator need not take himself away from his post to find a repair or resupply person, or to perform the repair and/or resupply by himself. As a result, efficiency and effectiveness of the process and utilization of personnel and personnel is enhanced.

Such traditional andon systems are less than desirable for a number of reasons. For example, it can be difficult to provide a central location for the enunciation indicator in a typical manufacturing or commercial setting where it can be readily seen from all points by repair or re-supply personnel. Also, such a system is typically not readily portable or adaptable for use in more than a single process or setting.

In an attempt to rectify some of the shortcomings of a traditional andon system, one prior approach utilizes a plurality of portable signal units and receiver units having lights mounted thereupon which are located adjacent the process stations. The signal units include switching elements so that an operator can illuminate the light to indicate a problem at that workstation. The signal units also include a wireless transmitter which sends a signal to receiver units, which may also be portable and provide a remote indication to a repair/resupply person. U.S. Pat. No. 7,006,792 to Wilson, titled “Wireless Andon Communication Method and System,” discloses one such system.

Although portable monitoring systems such as the one described in the preceding paragraph, or disclosed in U.S. Pat. No. 7,006,792 to Wilson provide improvements, in some cases, over a more traditional andon-type system, they still suffer from a number of the same drawbacks as the traditional andon system. Further improvement is desirable.

### BRIEF SUMMARY OF THE INVENTION

The invention provides an improved apparatus and method for monitoring and facilitating a process, which can be utilized in a wide variety of manufacturing, fabrication, assembly, storage, packaging and shipping, sales, and other industrial and commercial settings. Embodiments of the invention include a number of novel, unique and useful aspects which may be used individually or in various combinations with one another.

In one form of the invention, a method is provided for monitoring a process having multiple process stations. A signal unit is located at each process station to be monitored. Each signal unit has a signal light which is selectively, alternatively, operable in an off mode, a flashing mode and a continuously lighted mode. In at least one embodiment, the signal units are operatively linked in such a manner that when the signal light at a first signal station is selectively operated in the flashing mode, the signal lights of all of the remaining signal stations being monitored are automatically placed in a continuously lighted mode.

By virtue of this arrangement, enunciation of the initiation of the flashing light signal at the first signal station is substantially enhanced and made widely visible through enunciation by the continuously lighted signal lights of all of the other signal units at each of the other process stations. In this manner, the need for attention at the process station where the first signal unit is located can be communicated over a much wider field of view by virtue of the signal lights on all of the other signal units being illuminated in the continuously lighted mode. By having only the signal light at the first signal unit illuminated in the flashing mode, while the signal lights of the other signal unit are continually lighted, anyone viewing the illumination of any one of the signal lights will be able to tell at a glance that some sort of attention is needed at the process station where the first signal unit is located.

In some forms of the invention, the signal units are configured and operatively linked in such a manner that the signal light of the first signal unit will continue to flash and the remaining signal units will remain continuously lighted until such time as the signal light of the first signal unit is selectively switched out of operation in the flashing mode. In some forms of the invention, switching the first signal unit out of the flashing mode automatically returns all of the remaining signal units to their respective off modes.

In some forms of the invention, the signal units may be configured and operatively linked in such a manner that when the first signal unit is switched out of the flashing mode after operation in the flashing mode, the signal light of the first unit is automatically switched to the continuously lighted mode and remains continuously lighted until a further separate step of selecting the off mode is completed. By virtue of this arrangement, it can be seen at a glance that the process station where the first signal unit is located is receiving attention, while the processes at the other process station are continuing uninterrupted.

In some forms of the invention, the signal units may be configured and linked in such a manner that, if the second signal unit is selectively operated in the flashing mode while the first signal unit is operating in the flashing mode, the signal lights on all of the remaining signal units will remain continuously lighted until such time as the signal lights at both the first and second signal units are selectively switched out of operation in the flashing mode. The signal units may also be configured and operatively linked such that switching the lights of both the first and second unit out of a flashing mode automatically returns all of the remaining signal units to their respective off modes.

The signal lights of the signal units may include additional operating modes, such as alternate colors or flashing patterns, in some forms of the invention.

Some forms of the invention may also include a gateway unit which is operatively configured and connected to all of the signal units for transmitting signals to, and receiving signals from, each of the signal units, with the signals received from each of the signal units relating to the operating modes of the signal lights of each signal unit. The gateway and signal units may also be configured and operatively linked in such a manner that the gateway unit records a time based record of operation of each of the signal lights in at least one of the operating modes of the signal lights of the signal units.

In some forms of the invention, the gateway and signal units are configured and operatively linked in such a manner that the signal units are also operable as repeater units for communicating with other signal units and the gateway unit regarding the operating mode of the signal light of the repeater unit and any other of the signal units with which the repeater unit is communicating.

In some forms of the invention, the gateway and signal units are cooperatively configured for optimizing communication between the gateway unit, the signal units operating as repeater units, and the remaining signal units. Optimization of communication between the gateway unit, the signal units operating as repeater units, and the remaining signal units may be carried out in any appropriate manner.

Optimizing communication is carried out, in some forms of the invention, by measuring signal strength and/or reliability of the communication between the gateway units and the signal units, and designating the repeater units as required to provide communication of all signal units with the gateway unit either directly, or indirectly through one or more repeater units. Optimization may include designating repeater units to achieve a threshold signal strength and/or reliability for communication between the signal units, the repeater units and the gateway unit.

In some forms of the invention, each of the signal units is given a unique identification code which is detectable by the gateway unit and/or other signal units, and the gateway unit is provided with a list of the identification codes of the various signal units to be used in cooperation with that particular gateway unit. The optimization of communication between the gateway unit and those signal units assigned to that gateway unit may then utilize the identification codes of the signal units in performing the optimization.

In some forms of the invention, the optimization process may include having the gateway unit send a pinging signal to each of the signal units assigned to that gateway unit. Where relative signal strength of the communication between the gateway unit and the signal units assigned to that gateway unit are utilized for optimizing communication, the signal units will respond to the ping from the gateway unit with a return signal. The gateway unit may then measure the strength of the return signal from each signal unit and tabulate those return signal strengths in relation to the identification code for each signal unit. Optimization and assignment of certain ones of the signal units to function as repeaters may then be carried out on the basis of the relative signal strengths of the return signals from the various signal units.

In some forms of the invention, optimization may include a sequential or other form of automated search routine whereby the gateway unit sends out pinging signals to each of the signal units assigned to that gateway unit, with the presence or absence of return signals from the various signal units being recorded by the gateway unit. Optimization may then further include having the gateway unit designate one or more of the signal units from which a return signal was received as repeater units and directing those repeater units to send a pinging signal to one or more of the signal units from which a signal was or was not initially received. By iterating this process, the gateway unit arrives at a pattern of assigning signal units to function as repeater units which will optimize signal transmission to and from the gateway unit either directly with the signal units, or directly through the use those signal units which have been designated as repeaters.

In some forms of the invention, the gateway unit may provide a signal indicating that communication with some of the signal units cannot be established with the signal units and gateway unit positioned in their present locations, or that communication from, or to, a given signal unit is too weak or intermittent to provide for reliable communication. In some forms of the invention, such a condition can be corrected by relocating one or more of the signal units or the gateway unit, or by providing additional signal units functioning as repeaters.

In some forms of the invention, a record is compiled of the timing and duration of the operation of the signal units in various modes. This record may then be used, in some forms of the invention, for one or more useful purposes, such as enhancing productivity, continuous process improvement, or for enhancing total quality of the product or process.

A monitoring system, according to an embodiment of the invention, may include a gateway unit and a signal unit. The gateway and signal units each include transceivers and are configured for two-way communication with one another. The signal unit includes a signal light, a signal light controller, and an operator input element. The signal light is alternatively operable in an off mode, a flashing mode or a continuously lighted mode.

The signal light controller may be operatively connected to the signal unit transceiver, the signal light and the operator input element for selectively controlling the signal light in the off, flashing, or simultaneously continuously lighted modes, in accordance with signals from the signal unit transceiver and the operator input element. The operator input element may take the form of a single or multiple position switch, or any other appropriate element configured for receiving an operator input initiating an operator input signal to the signal unit controller.

In some forms of the invention, a signal unit may be configured for operation as a repeater which is capable of forwarding communications in either direction between the gateway unit and another signal unit. In embodiments of the invention including at least a second signal unit, either or both of the first and second signal units may be configured for operation as a repeater.

Gateway and signal units, according to an embodiment of the invention, may be cooperatively configured and operatively connected for automatically optimizing communications between the gateway and signal units.

Other aspects, objects and advantages of the invention will be apparent from the following detailed description and accompanying drawings of exemplary embodiment of the invention.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of an exemplary embodiment of a monitoring system, according to the invention;

FIG. 2 is a block diagram of an exemplary embodiment of a gateway unit, according to the invention;

FIG. 3 is a schematic illustration of the gateway unit of FIG. 2;

FIG. 4 is a block diagram of an exemplary embodiment of a signal unit, according to the invention; and

FIG. 5 is a schematic illustration of the signal unit of FIG. 4.

While the invention is described in connection with certain preferred embodiments, there is no intent to limit the invention to those embodiments. On the contrary, the intent is to cover all alternatives, modifications and equivalents as included within the spirit and scope of the invention.

### DETAILED DESCRIPTION OF THE INVENTION

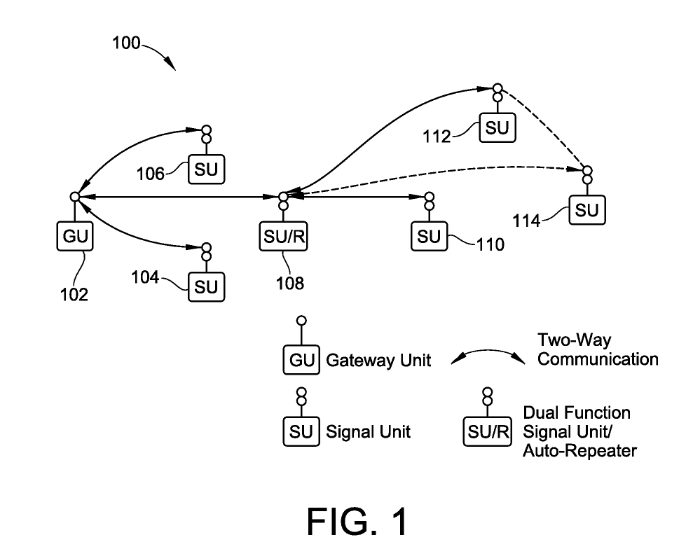

FIG. 1 shows a first exemplary embodiment of a downtime monitoring system 100, according to an embodiment of the invention. The first exemplary embodiment of the monitoring system 100 includes one gateway unit 102 and six signal units 104, 106, 108, 110, 112, 114. The signal units 104, 106, 108, 110, 112, 114 are shown as they might be arrayed on a factory floor, for example, with each of the signal units 104, 106, 108, 110, 112, 114 being disposed adjacent a given process station (not shown) for use in performing a process.

In the exemplary embodiment of the monitoring system 100, all of the signal units 104, 106, 108, 110, 112, 114 are identical, and are configured to be capable of operation as either a basic signal unit, or as a repeater. In the exemplary embodiment 100, the signal unit 108 is shown operating as a repeater unit. Signal unit/repeater 108 communicates directly with signal units 110, 112, 114. In the arrangement shown in FIG. 1, the gateway unit 102 is wirelessly communicating directly with signal units 104, 106, and 108. For various reasons, such as signal units 110, 112 and 114 being located at so great a distance from the gateway unit 102, or the presence of intervening structures beyond signal unit 108, the gateway unit 102 may be incapable too achieving reliable wireless communication directly with signal units 110, 112, 114.

In an alternate embodiment of the invention, signal unit/repeater 108 is not able to communicate directly with signal unit 114 due to distance or an obstruction, such as a wall or large machine blocking the signal (note the phantom line between signal units 108 and 114). In this alternate embodiment signal unit 112 acts as a second repeater relaying the signal from signal unit/repeater 108 to signal unit 114 (note the line in phantom between signal units 112 and 114). In the manner, the gateway unit 102 may designate multiple signal units as repeater units to ensure reliable communication between all of the signal units in the monitoring system 100.

The exemplary embodiment of the monitoring system 100 is configured and its units are operatively interconnected in such a manner that the gateway unit 102 will recognize that communication cannot reliably be established with signal units 110, 112, 114. When such a situation occurs, the gateway unit 102 will designate one of the signal units, in this case signal unit 108, to function as a repeater to facilitate communication between signal units 110, 112, 114 and the gateway unit 102 via the signal unit/repeater 108.

In various forms of the invention, the monitoring system 100 will use an optimization routine, such as one of those described above in the Summary of the Invention section, for deciding which of the signal units 104, 106, 108 should be used as a repeater. The optimization routine may also be utilized for determining which of the signal units 104, 106, 108, 110, 112, 114 should communicate directly with the gateway unit 102, and which of the signal units 104, 106, 108, 110, 112, 114 should communicate indirectly with the gateway unit 102 via one or more others of the signal units 104, 106, 108, 110, 112, 114 designated as a repeater.

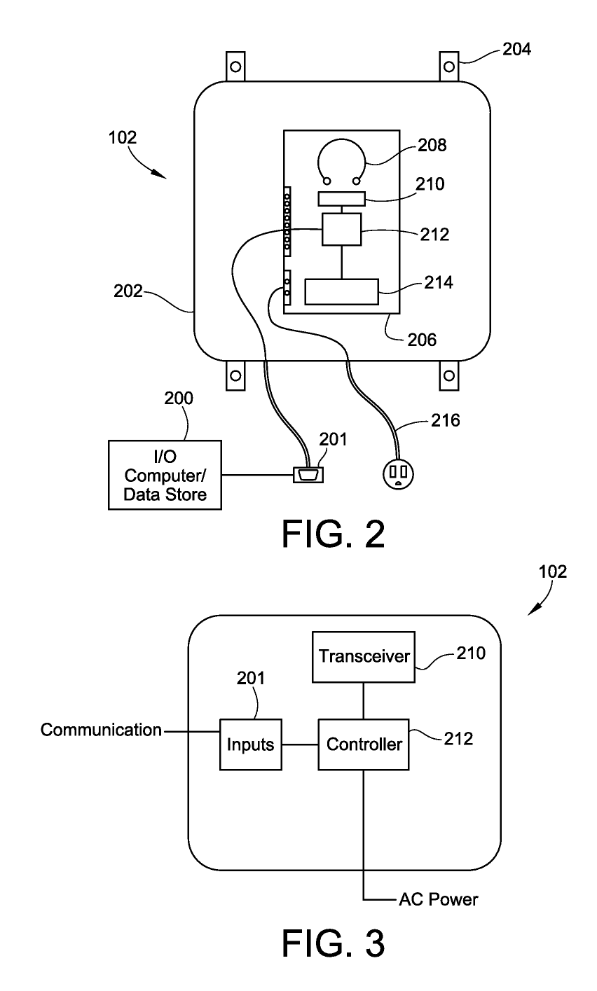

FIGS. 2 and 3 provide a block diagram of an exemplary embodiment of the internal components of the gateway unit 102, and a schematic illustration, respectively, of the gateway unit 102. It will be understood, by those having skill in the art, that the embodiment shown in FIGS. 2 and 3 is provided for the purpose of explaining the exemplary embodiments of the invention more thoroughly, and that a gateway unit, according to embodiments of the invention, may take a variety of other forms in various embodiments of the invention. It will be further noted, as illustrated in FIG. 2, that some form of an appropriate input/output (I/O) device 200, such as a computer or other data storage element may be connected to the gateway unit 102 for recording the operation of the various signal units 104, 106, 108, 110, 112, 114 in the exemplary embodiment of the monitoring system 100. The I/O device 200 may also be used to input data into the gateway unit 102 relating to the specific signal units in the monitoring system. As will be explained below, such data may include operating frequencies and/or signal unit IDs. In the embodiment shown, the gateway unit 102 includes an enclosure 202 having an input port 201 for connection with the I/O device. The enclosure 202 further includes four mounting tabs 204. The enclosure 202 houses a control and I/O board 206 with an antenna 208 coupled to a transceiver 210. The transceiver 210 is also coupled to a controller 212, which is coupled to relays 214. In this embodiment, the gateway unit 102 also includes plug 216 configured to plug into a standard 110V or 220V AC outlet.

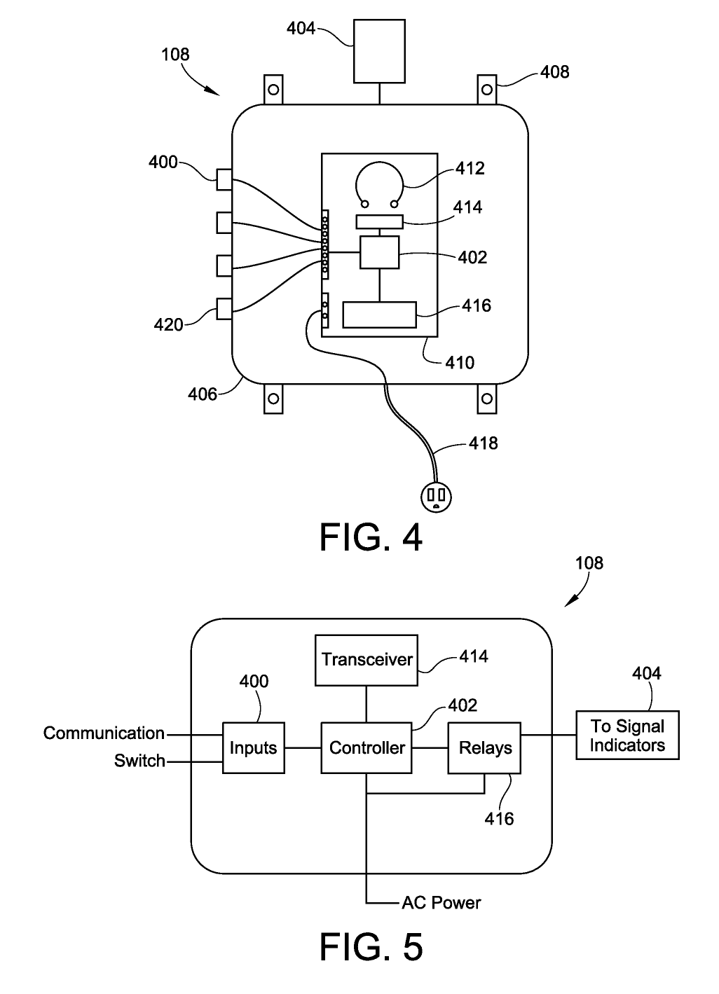

In similar fashion, FIGS. 4 and 5, respectively, show a representative component view of the signal unit 108, and a schematic view of that unit 108. Only the signal unit 108 is illustrated in FIGS. 4 and 5, but it should be noted that all of the signal units 104, 106, 108, 110, 112, 114 in the exemplary embodiment of the monitoring system 100 are identical and are capable of functioning as either a signal unit or a repeater. It will be understood, however, that in other embodiments of the invention not all of the signal units need be configured to operate as both a signal unit and a repeater.

As shown in FIG. 4, the signal unit 108 includes switch inputs 400 which can be utilized by an operator to provide an operator input to a signal light controller 402, which is, in turn, utilized for lighting one or more signal lights or other types of visual indicators 404 on the signal unit 108. The operator may cause one or more signal lights to flash, continuously light, or turn off using the switch inputs 400. In the embodiment shown, the signal unit 108 includes an enclosure 406 with four mounting tabs 408. The enclosure 406 houses a control and I/O board 410 with an antenna 412 coupled to a transceiver 414. The transceiver 210 is also coupled to the controller 402, which is coupled to relays 416. In this embodiment, the signal unit 108 also includes plug 418 configured to plug into a standard 110V or 220V AC outlet. In at least one embodiment, the signal unit 108 includes a response button 420, which is configured to be used by a responder to indicate their presence to address the issue that precipitated the initiation the flashing signal light. In at least one embodiment, pressing the response button resets the switch inputs 400.

Referring again to the exemplary embodiment of FIG. 1, in the monitoring system 100, the operator has a choice of several different switch inputs. For the purposes of illustration, it will be assumed that the visual indicator 404 (in FIG. 4) of the exemplary embodiments of the signal units 104, 106, 108, 110, 112, 114 each include a pair of signal lights, specifically a yellow light and a red light, both capable of operating in an off mode, a flashing mode, or a continuously illuminated mode.

If an operator at one or more of the process stations in the exemplary system shown in FIG. 1 detects a problem, the operator uses the appropriate switch input to illuminate the red signal light, and cause it to flash continuously. When such an input is provided at one of the signal units 104, 106, 108, 110, 112, 114, the configuration and operative connection of all of the signal units 104, 106, 108, 110, 112, 114 will cause the red signal light and all of the other signal units 104, 106, 108, 110, 112, 114 to be illuminated in a continuously lighted mode.

For example, if an operator at the process station associated with signal unit 106 detects a problem needing attention and uses the switch input of signal unit 106 to illuminate the red signal light of unit 106 in a flashing mode, the red signal lights in the visual indicators of all of the other signal units 104, 108, 110, 112, 114 will be illuminated in a continuously lighted mode. By virtue of this operation, a person standing on the factory floor near signal unit 114, for example, will be alerted that there is some sort of a problem needing attention at one of the signal units 104, 106, 108, 110, 112, 114 associated with gateway unit 102.

If only the signal unit 106 were flashing at either a remote location from the process station, or at the process station, as would be the case using prior approaches to downtime monitoring systems, the person standing adjacent signal unit 114 might not otherwise be alerted to the need for attention at the process station associated with signal unit 106, if they were not looking directly at signal unit 106.

With the monitoring system 100 of the present invention, however, the attention of the person standing adjacent signal unit 114 is captured by the continuously lighted signal light of signal unit 114, they can turn and quickly, at a glance, see that it is the process station being monitored by signal unit 106 where attention is needed. If the person standing at signal unit 114 is a designated responder (such as a repair or re-supply person, for example), he may then proceed to signal unit 106 to address the problem detected by the operator at the process station being monitored by signal unit 106.

Once the responder man reaches signal unit 106, he can use the switch inputs of signal unit 106 to switch the signal light at signal unit 106 from the flashing mode to a continuously lighted mode, indicating that the problem is being addressed. The remaining signal units 104, 108, 110, 112, 114 are then simultaneously automatically turned off. In this manner, a supervisor or manager observing the process from some distance off will be able to determine at a glance that solutions to the problem are being implemented at the process station associated with signal unit 106, and that the process is continuing, or could be continued, at all of the other process stations being monitored by the monitoring system 100. When the problem is solved, the responder uses the switch inputs of signal unit 106 to cause the signal light at signal unit 106 to be returned to the off mode.

The gateway unit 102 of the exemplary embodiment of the monitoring system 100 is configured to receive time-based signals from all of the signal units 104, 106, 108, 110, 112, 114, which indicating the length of time and relative periods of time that the visual indicators are in their various flashing, continuously lighted, and off modes. In this manner, a time-based record can be maintained showing when a given problem occurred, how long it took the responder to respond and begin fixing the problem, and how long it took to implement solutions to the problem and return the system to a fully functioning mode of operation. From such information, process improvements can be determined and affected.

In the exemplary embodiment of the monitoring system 100, the signal units 104, 106, 108, 110, 112, 114 also include a second signal light in their visual indicators. For purposes of illustration, this second light may be a different colored light, such as yellow, or may be differentiated by a flashing pattern different from the red signal indicator described above. The purpose of this second color of indicator, is to allow an operator to alert appropriate personnel to conditions needing attention at the process station other than problems requiring repair. For example, such additional lights may be utilized to indicate that re-supplying of raw materials is necessary or imminent at the work station.

In general, operation of the second signal light is identical to that described above for the first (red) signal light, in the exemplary embodiment of the invention. With the yellow lights in the exemplary embodiment 100, however, a person standing at signal unit 114 may be charged with re-supplying all of the process stations, for example. The operator at signal unit 106 may use a switched input to illuminate the signal light of the visual indicator at signal unit 106 in a flashing yellow mode, which then causes the yellow signal lights at all of the other work stations 104, 108, 110, 112, 114 to be illuminated in a continuously-lighted yellow mode.

A re-supply person standing adjacent to signal unit 114 will then be alerted to the fact that re-supply is needed at one of the process stations being monitored by the monitoring system 100. At a glance, that person can determine that it is station 106 which needs re-supply. The re-supply person can proceed to station 106, change the signal light from continuously flashing yellow to continuously illuminated yellow with the simultaneous result that the monitoring system 100 will return all of the yellow signal lights at the other signal units 104, 108, 110, 112, 114 to the off mode. Once again, a supervisor or a manager standing at some distance from the process being monitored by the monitoring system 100 will be able to see that the re-supply is in process.

It is further contemplated that the signal units 104, 106, 108, 110, 112, 114 may be configured to have signal lights of more than two colors to signify, for example, different types of servicing needs, or for indicating varying degrees of urgency to the responder. In an embodiment of the invention, the signal light controller 402 (in FIG. 4) may be configured to cause the one or more signal lights in the signal units 104, 106, 108, 110, 112, 114 to flash in distinct flashing patterns, wherein the flashing patterns may signify, for example, different types of servicing needs, or for indicating varying degrees of urgency to the responder.

Further, in the exemplary embodiment of the invention 100, the gateway unit 102 is capable of creating a time-based record of the re-supply operation, showing which unit needed re-supply, how long it took the re-supply person to react and begin re-supply, and when re-supply was accomplished. This data may then be utilized to optimize the process, or implement improvements.

It will be understood by those having skill in the art, that the I/O, computer/data storage element illustrated in FIG. 2 may either be incorporated into the gateway unit 102, or be a stand alone unit located adjacent to, or remote from, the gateway unit 102 and appropriately operatively linked through wires or wirelessly with the gateway unit 102, in various embodiments of the invention.

Those having skill in the art will recognize, that in embodiments of the invention such as those illustrated in FIGS. 2-5, the gateway unit 102 and signal units 104, 106, 108, 110, 112, 114 may also include an integrated power supply which eliminates the need for a transformer or external power supply. This is a significant advantage over prior monitoring units and systems which utilized an external power conversion unit. It should be understood, however, that the present invention is not limited to having an integrated power supply located within the gateway unit 102 and signal units 104, 106, 108, 110, 112, 114.

Furthermore, in at least one embodiment of the invention, the control boards on the gateway unit 102 and signal units 104, 106, 108, 110, 112, 114 include integrated wireless antennae and transceivers, such that only one transceiver per gateway unit and signal unit is used, regardless of the number of signal units deployed. The wireless data transmission may occur in the radio or other frequency ranges. Moreover, the wireless data may be transmitted using a protocol that utilizes multiple frequencies within each transmission path, wherein, for example, each signal unit has a unique frequency and a unique ID. The wireless data may also be transmitted using a protocol that passes data between units using a frequency-hopping method. Each of these methods allows for a reliable and robust method of data transmission.

Those having skill in the art will also recognize that, by virtue of the aspects of the invention described above, a single gateway unit can communicate to a very large number of signal units, because even where the communication frequency is set at a specific frequency, a single gateway unit can use a unique identification code to communicate with each signal unit associated with the gateway unit, without other signal units being affected.

In some embodiments of the invention, it is also contemplated that multiple frequencies may be used for communication by the gateway unit and/or that a frequency hopper arrangement may be utilized.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A monitoring system comprising:
a gateway unit; and
a signal unit;
the gateway and signal units each including transceivers and being configured for two-way communication with one another;
the signal unit including a signal light, a signal light controller, and an operator input element;
the signal light being alternatively operable in an off mode, a flashing mode or a continuously lighted mode;
the signal light controller being operatively connected to the signal unit transceiver, the signal light and the operator input element for selectively controlling the signal light in the off, flashing, or the continuously lighted mode in accordance with signals from the signal unit transceiver and the operator input element;
the operator input element being configured for receiving an operator input initiating an operator input signal to the signal unit controller.

2. The monitoring system of claim 1, wherein the signal unit is configured for operation as a repeater for forwarding communications in either direction between the gateway unit and another signal unit.

3. The monitoring system of claim 2, further comprising at least a second signal unit, with either or both of the first and second signal units being configured for operation as a repeater.

4. The monitoring system of claim 3, wherein the gateway and signal units are cooperatively configured and operatively connected for automatically optimizing communication between the gateway and signal units.

5. The monitoring system of claim 1, wherein the signal unit further comprises a plurality of signal lights, wherein the plurality of signal lights include signal lights of more than one color.

6. The monitoring system of claim 1, wherein the signal light controller is configured to cause the signal light to flash in two or more distinct flashing patterns.

7. The monitoring system of claim 1, wherein the signal unit further comprises a response button configured to be pressed by a responder responding to a signal light in flashing mode.

8. The monitoring system of claim 1, further comprising a second signal unit, wherein the signal unit and the second signal unit each are configured to transmit and receive signals at different frequencies, and wherein the signal unit and the second signal unit each has a unique ID which can be recognized by the gateway unit.

9. A method for monitoring a process having multiple process stations, comprising:
placing a signal unit at each process station to be monitored, the signal unit having a signal light being selectively and alternatively operable in an off mode, a flashing mode, and a continuously lighted mode; and
operatively linking the signal units such that when the signal light at a first signal station is selectively operated in the flashing mode the signal lights of all of the remaining signal stations being monitored are automatically placed in the continuously lighted mode;
whereby observation of the signal light placed at any one of the process stations being monitored will enunciate the selective operation of the signal light at the first signal station in the flashing mode.

10. The method of claim 9, further comprising, configuring and operatively linking the signal units in such a manner that:
the signal light of the first signal unit will continue to flash and the remaining signal units will remain continuously lighted until such time as the signal light at the first signal unit is selectively switched out of operation in the flashing mode; and
such that switching the first signal unit out of the flashing mode automatically returns all of the remaining signal units to their respective off modes.

11. The method of claim 10, further comprising configuring, and operatively linking, the signal units in such a manner that when the first unit is switched out of the flashing mode after operating in the flashing mode, the signal light of the first signal unit is automatically switched to the continuously lighted mode, and remains continuously lighted until a further separate step of selecting the off mode is completed.

12. The method of claim 10, further comprising configuring, and operatively linking, the signal units in such a manner that, if a second signal unit is selectively operated in the flashing mode while the first signal unit is operating in the flashing mode:
the signal lights on all of the remaining signal units will remain continuously lighted until such time as the signal lights of both the first and second signal units are selectively switched out of operation in the flashing mode; and
such that switching the signal lights of both the first and second signal units out of the flashing mode automatically returns all of the remaining signal units to their respective off modes.

13. The method of claim 9, wherein placing a signal unit at each process station to be monitored, further comprises placing a signal unit having a plurality of signal lights in more than one color, at each process station to be monitored.

14. The method of claim 9, wherein placing a signal unit at each process station to be monitored, further comprises placing a signal unit having signal light controller configured to cause the signal lights to flash in two or more distinct flashing patterns at each process station to be monitored.

15. The method of claim 9, further comprising providing a gateway unit operatively connected to all of the signal units, and configured to transmit signals to, and receive signals from, each of the signal units, the signals relating to the operating mode of the signal lights at each signal unit.

16. The method of claim 15, further comprising configuring, and operatively linking, the gateway and signal units in such a manner that the gateway unit records a time-based record of operation of each of the signal lights in at least one of the operating modes of the signal lights of the signal units.

17. The method of claim 15, further comprising configuring, and operatively linking, the gateway and signal units in such a manner that:
the signal units are also operable as repeater units for communicating with other signal units and the gateway unit regarding the operating mode of the signal light of the repeater unit and any other of the signal units with which the repeater unit is communicating; and
the gateway and signal units are cooperatively configured for optimizing communication between the gateway unit, the signal units operating as repeater units, and the remaining signal units.

18. The method of claim 17, wherein optimizing communication comprises measuring signal strength of the communication between the gateway units and the signal units and designating the repeater units to provide communication to other signal units with the gateway unit either directly, or indirectly through one or more repeater units.

19. The method of claim 18, wherein optimizing communication further includes designating repeater units to achieve a threshold signal strength for communication between the signal units, the repeater units and the gateway unit.

20. A monitoring system comprising:
a gateway unit having a transceiver, and configured for two-way communication; and
a signal unit having a transceiver, one or more signal lights, a signal light controller, and an operator input element, the signal unit configured for two-way communication with the gateway unit, and configured for operation as a repeater for forwarding communications in either direction between the gateway unit and another signal unit, wherein the signal unit has a unique ID and a unique operating frequency, each of which can be recognized by the gateway unit;
wherein each of the one or more signal lights is alternatively operable in an off mode, a flashing mode or a continuously lighted mode;
wherein the signal light controller is operatively connected to the signal unit transceiver, the one or more signal lights, and the operator input element for selectively controlling the one or more signal lights in the off, flashing, or the continuously lighted mode in accordance with signals from the signal unit transceiver and the operator input element, the signal light controller configured to cause each of the one or more signal lights to flash in two or more distinct flashing patterns;
wherein the gateway unit is operatively connected to the signal unit, and configured to transmit signals to, and receive signals from, the signal unit, the signals relating to the operating mode of the signal lights at each signal unit, the gateway unit further configured to record a time-based record of operation of each of the one or more signal lights in at least one of the operating modes of the signal lights of the signal unit;
wherein the gateway and signal units are cooperatively configured and operatively connected for automatically optimizing communication between the gateway and signal units; and
wherein the operator input element is configured for receiving an operator input initiating an operator input signal to the signal unit controller.
